(19) United States
(12) Patent Application Publication
(10) Pub. No.: US 2013/0070940 A1
(43) Pub. Date: Mar. 21, 2013

(54) CIRCUIT AND APPARATUS FOR CONNECTING A MEMS MICROPHONE WITH A SINGLE LINE

(71) Applicants: Aleksey S. Khenkin, Nashua, NH (US); Martin Kessler, Somerville, MA (US)

(72) Inventors: Aleksey S. Khenkin, Nashua, NH (US); Martin Kessler, Somerville, MA (US)

(73) Assignee: Analog Devices, Inc., Norwood, MA (US)

(21) Appl. No.: 13/237,482

(22) Filed: Sep. 20, 2011

(51) Int. Cl. H04R 3/00

(52) U.S. Cl. 381/111

(57) ABSTRACT

A circuit electrically connects a MEMS microphone with a single line transmitting both a DC power signal and an AC information signal. The MEMS microphone has a power interface for receiving the power signal, and an information interface for delivering the information signal. In such embodiments, the circuit includes a pair of lines that separate the power and information signals. To that end, the circuit has an information line configured to connect with the information interface of the MEMS microphone, and a power line configured to connect with the power interface of the MEMS microphone.

### FIELD OF THE INVENTION

The invention generally relates to MEMS microphones and, more particularly, the invention relates to electrically connecting MEMS microphones with a single line.

### BACKGROUND OF THE INVENTION

The professional audio industry often provides DC power to microphones across the same wire/cable used to deliver the output audio signal. This is known in the art as “phantom power.” Recently, this technique has been used in other, non-professional audio industries, such as the automotive industry. For example, many automobiles offer hands-free communication systems with microphones using a phantom powering scheme.

Microphone performance and connection requirements using this scheme in automotive applications often comply with industry-wide accepted standards, such as the ITU-T P.100 VDA Specification for Car Hands-Free Terminals. This standard provides 1) a ground wire and 2) a single signal wire that delivers both power to the microphone while transmitting the output microphone signal. In a corresponding manner, this standard applies directly to ECM microphones, which have a first pin/pad/interface for both the audio signal and power, and a second pin/pad/interface for ground.

MEMS microphones, however, are becoming increasingly popular due to their lower power requirements, smaller footprint, and other performance attributes. Applications that used ECM microphones in the past now often use MEMS microphones. Unfortunately, MEMS microphones are not configured to implement a phantom powering scheme.

### SUMMARY OF THE INVENTION

In accordance with one embodiment of the invention, a circuit electrically connects a MEMS microphone with a single line transmitting both a DC power signal and an AC information signal. The MEMS microphone has a power interface for receiving the power signal, and an information interface for delivering the information signal. In such embodiments, the circuit includes a pair of lines that separate the power and information signals. To that end, the circuit has an information line configured to connect with the information interface of the MEMS microphone, and a power line configured to connect with the power interface of the MEMS microphone.

The information line has a DC filter and an information signal output. Accordingly, the DC filter mitigates DC power signals transmitted from the information signal output and toward the information interface of the MEMS microphone. In a corresponding manner, the power line has an AC filter and a power signal input. Accordingly, the AC filter mitigates information signals directed toward the microphone power interface along the power line from the power signal input. The circuit also has an external interface coupled with both the information signal output and the power signal input. The external interface is a single electrical node that is configured to transmit both a power signal and an information signal.

The lines may include a number of additional components. For example, power line may include a voltage step down module. Some embodiments of the voltage step down module include a diode that sets the maximum voltage on the power line. As another example, the signal line may include an amplifier having an amplifier input for receiving an information signal from the information interface of the MEMS microphone, and an amplifier output for delivering an amplified information signal toward the information signal output. The amplifier also may receive power from the power line.

The amplifier input may include a differential input with first and second inputs. The first input may be grounded while the second input is coupled with the MEMS microphone. Alternatively, the first input may couple with a first MEMS microphone, and the second input may couple with a second MEMS microphone.

In some embodiments, the external interface includes a prong or female interface for connecting with a complimentary component terminating a shielded wire. Moreover, the circuit may be part of a larger apparatus that is coupled with one or more of the noted MEMS microphones.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a microphone system coupled with a head end in a conventional audio system.

FIG. 2 schematically shows a circuit for coupling a MEMS microphone system, which has three ports, to a system that has two ports, such as a phantom powering scheme.

FIG. 3 schematically shows more details of one implementation of the circuit of FIG. 2 with a single MEMS microphone system.

FIG. 4 schematically shows more details of one implementation of the circuit of FIG. 2 with a pair of MEMS microphone systems.

### DESCRIPTION OF ILLUSTRATIVE EMBODIMENTS

In illustrative embodiments, a MEMS microphone system has an interface circuit enabling it to couple with systems that use a single port for both power and microphone signal transmission. To that end, the interface circuit has filtering, amplification and power control elements that form separate signal and power paths for interfacing with the packaged MEMS microphone. The components 1) prevent transmission of power along the signal path and 2) prevent transmission of the signal along the power path. Accordingly, both the signal path and power path may connect to a single line that communicates both the power and signal between the microphone system and an external system (e.g., a legacy system). Details of illustrative embodiments are discussed below.

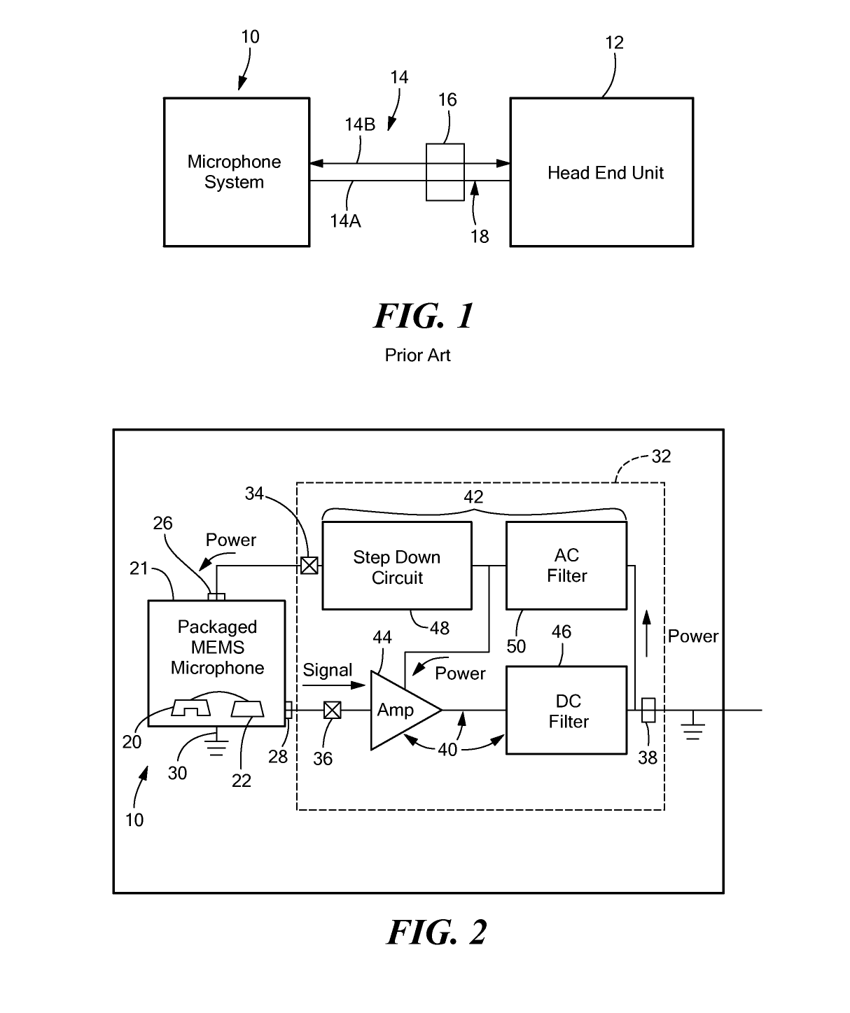

FIG. 1 schematically shows a microphone system 10 coupled with a head unit 12 in a conventional audio system. The microphone system 10 receives and transmits acoustic signals (i.e., reproduced versions of received acoustic signals) along a shielded transmission line 14 to a head unit 12. For example, the microphone system 10 may receive a human voice signal, convert it into electronic form, and transmit it to the head unit 12 along the same transmission line 14. Upon receipt, the head unit 12 may process the incoming signal for any number of purposes, such as for delivering an audio signal from a speaker system, or for storage in a computer system.

The head unit 12 also delivers power to the microphone system 10 along the same wire that delivers the acoustic signal. Among other things, the audio system may be a hands free system within an automobile. When using this type of system, a driver or other occupant can talk on the telephone or deliver verbal commands to the underlying system without the use of his or her hands.

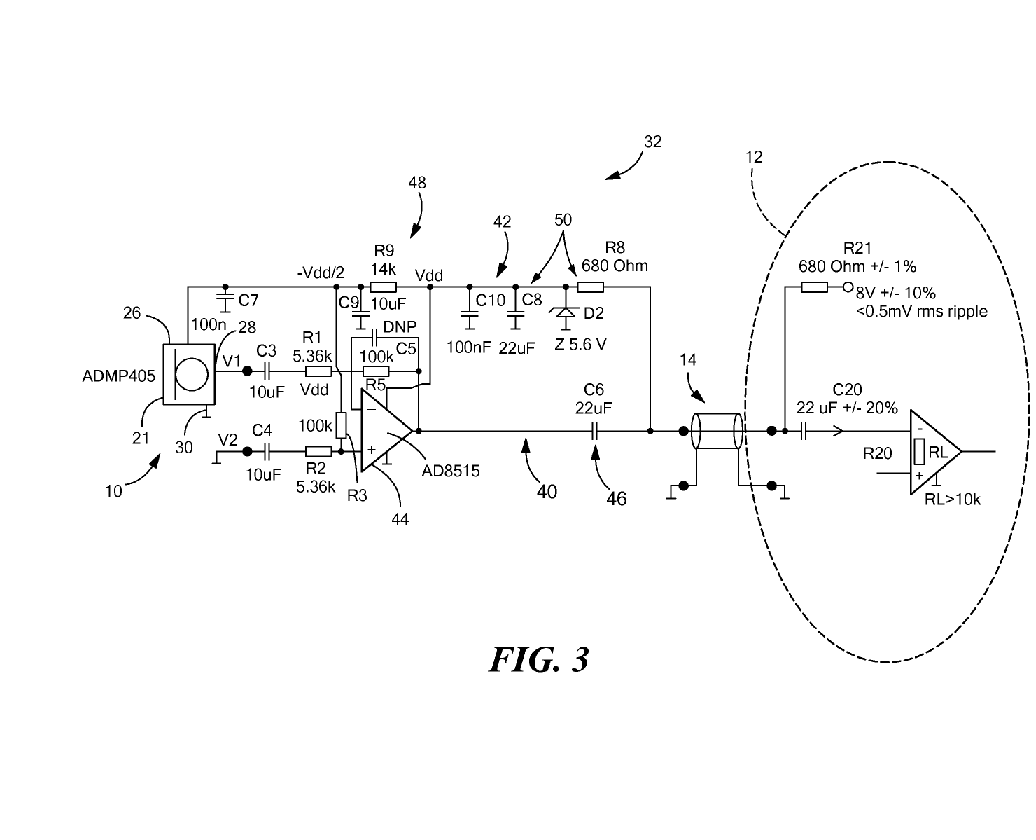

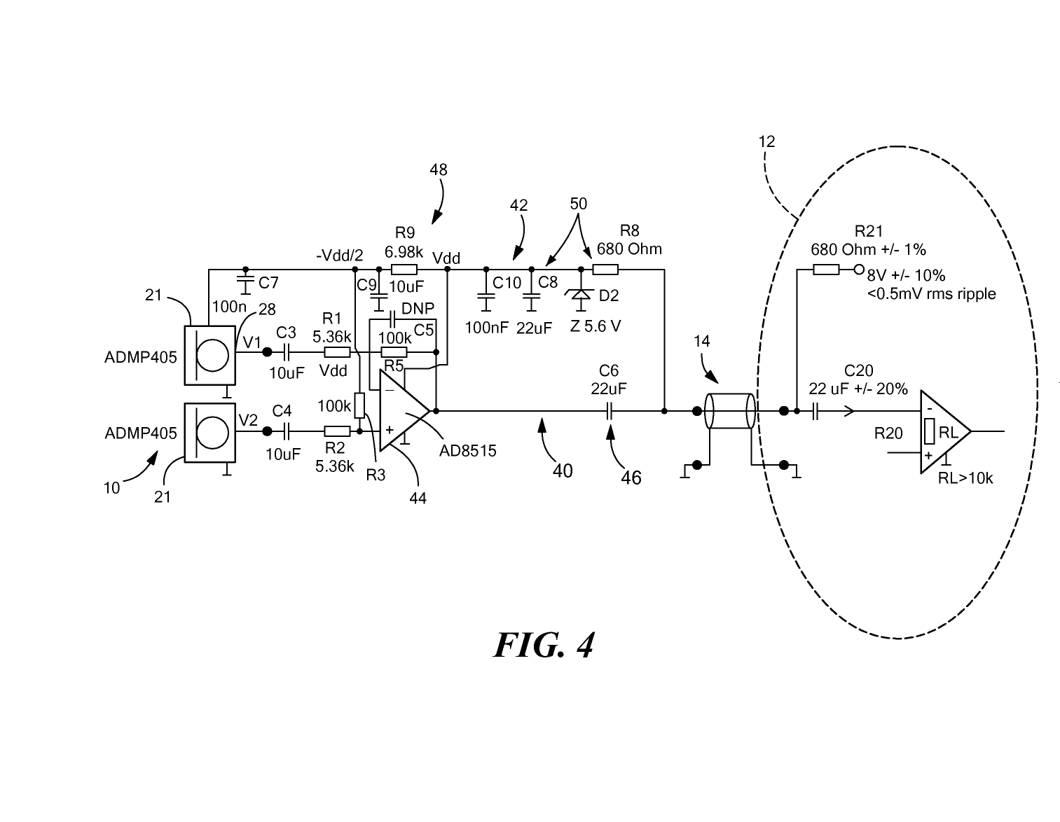

As suggested above, this system may use so-called “phantom power” schemes, which provide DC power and the acoustic signal (often referred to herein simply as the “signal”) in the same wire. As known by those in the art, widely used standards, such as the ITU-T P.100 VDA Specification for Car Hands-free Terminals, define microphone performance and connection requirements. In summary, this noted standard specifies that the line 14 must include a ground wire 14A and a second wire that transmits both the acoustic signal and the power (the “signal/power wire 14B”). An EMI shield, which may also act as a return power path, surrounds both wires 14A and 14B to prevent interference from outside sources. The signal content of the signal/power wire 14B is AC coupled over a capacitor (discussed below with respect to FIGS. 3 and 4) while a DC voltage is supplied over a series resistor (also discussed below with respect to FIGS. 3 and 4). In practice, the microphone system 10 has a shielded harness 16 with two prongs 18—one prong 18 connected to the signal/power wire 14B, and the other wire connected to the ground wire 14A. The shielded harness 16 and/or shielded wires may be referred to herein as the “shielded transmission line 14.”

At the core of the microphone system 10 is one or more packaged MEMS microphones 20 (see FIG. 2). For example, the microphone system 10 may include a model number ADMP405 packaged MEMS microphone, distributed by Analog Devices, Inc. of Norwood, Mass. As known by those in the art, packaged MEMS microphones, such as the ADMP405 microphone, include a MEMS microphone chip 20 that receives and converts acoustic signals into an electronic signal, and an application specific integrated circuit chip (“ASIC 22” or “ASIC chip 22”) to control the microphone chip 20, amplify the converted acoustic signal, and interface with other components. The microphone chip 20 may have a variable capacitor (as in the ADMP405), piezoresistor, or other apparatus to convert the acoustic signal into an electrical signal. Thus, using the ADMP405 microphone as an example, the microphone chip 20 has a flexible diaphragm that flexes in response to receipt of an acoustic signal. This flexure causes the diaphragm to change its distance from another plate of the capacitor (the backplate), thus generating a low power signal corresponding to the input acoustic signal. The ASIC chip 22 conditions and amplifies this signal for use by external components.

Both the microphone chip 20 and ASIC chip 22 are housed within a shielded package (not explicitly shown) to form a packaged microphone 21. The package has an aperture for permitting acoustic signals to strike/contact the diaphragm/variable capacitor of the microphone chip 20, and a series of contacts for communicating with other components. For additional details about an illustrative packaged MEMS microphone design, see U.S. Pat. No. 7,961,897, assigned to Analog Devices, Inc. Norwood, Mass., the disclosure of which is incorporated herein, in its entirety, by reference.

In a manner similar to other packaged MEMS microphones, the packaged microphone 21 of FIG. 2 has at least three separate electrical interfaces/pads/contacts; one for power (“power contact 26”, a second for signal transmission (“signal contact 28”), and a third for ground (“ground contact 30”). Thus, absent reconfiguration, the packaged ADMP405 microphone is incompatible with the head unit of FIG. 1, which can connect with packaged microphones 21 having two electrical interfaces only. The inventors recognized this problem and solved it.

It should be noted that principles of various embodiments apply to other types of systems, packaged MEMS microphones and head units. Accordingly, discussion of the noted standard, noted microphones, or automotive audio systems are examples only and not intended to limit the scope of various embodiments.

To solve this problem, the inventors developed an interface circuit 32 with a single head-end-facing port for transmitting both signal and power (i.e., for interfacing directly with the shielded line 14), and a pair of microphone-facing ports that each connect to separate corresponding ports on the packaged microphone 21. Specifically, the first of the pair of microphone-facing ports delivers power to the power contact 26 on the packaged microphone 21 from the power/signal wire of the transmission line 14. This port may be referred to herein as the “interface circuit power port 34.” In a corresponding manner, the second of the pair of microphone-facing ports receives the acoustic signal from the signal contact 28 of the packaged microphone 21, and transmits it toward the head unit 12 via the intervening interface circuit 32. This port 36 may be referred to herein as the “interface circuit signal port 36.”

To those ends, the interface circuit 32 has two branches that begin at the interface circuit's signal and power ports 34 and 36 and terminate at the above noted single port, which interfaces with the power/signal wire 14B of the transmission line 14. This single head-end-facing port may be referred to herein as the “interface circuit power/signal port 38.” More specifically, the two branches may be considered to be a “signal branch 40,” which transmits the acoustic signal, and a “power branch 42,” which transmits the power. FIG. 2 shows a simplified schematic diagram of these two branches.

The signal branch 40 has an amplifier 44 for amplifying the converted acoustic signal from the signal contact 28 of the packaged microphone 21, and a DC filter 46 for substantially preventing DC signals from being transmitted to the signal contact 28 of the package. Accordingly, the DC filter 46 prevents the power signal from being transmitted to the signal contact 28 of the microphone package via the signal branch 40. In other words, the DC filter 46 prevents transmission of power received at the interface circuit power/signal port 38 along the signal branch 40.

In a corresponding manner, the power branch 42 has a step down circuit 48 (e.g., a linear regulator, or other circuit discussed below) for ensuring that the microphone power contact 26 receives an appropriate voltage. For example, the head unit 12 may transmit an 8 volt DC power signal, which may be too high for the packaged microphone 21. The step down circuit 48 thus may reduce the 8 volt DC power signal to an appropriate level, such as 4 volts DC.

The power branch 42 also has an AC filter 50 that substantially mitigates transmission of the converted acoustic signal toward the power contact 26 of the package. More specifically, since both the power and acoustic signal are transmitted at the interface circuit power/signal port 38, without the AC filter 50, the AC signal from the packaged microphone 21 would transmit back toward the packaged microphone 21 via the power branch 42. Undesirably, this would corrupt powering of the packaged microphone 21. The AC filter 50 prevents this undesirable result.

In addition to the various ports, the interface circuit 32 also has a ground path that electrically connects the ground wire 14A of the transmission line 14 with the ground contact 30 of the packaged microphone 21. FIG. 2 shows this additional ground path only schematically as a ground symbol. Accordingly, the interface circuit 32 connects the two wires 14A and 14B of the shielded transmission line 14 with the three contacts 26, 28, and 30 of the packaged microphone 21.

FIGS. 3 and 4 show specific examples of one implementation of various embodiments of the invention. It should be noted that although these examples have specific values for the components and have certain requirements, they are not intended to limit all embodiments of the invention. Instead, they merely are illustrative of two ways that one skilled in the art may implement various embodiments.

FIG. 3 schematically shows a first implementation of the circuit shown in FIG. 2 using a single packaged microphone 21. Specifically, in this circuit, the electrical, analog output audio/acoustic signal of the packaged microphone 21, the Analog Devices Model number ADMP404 microphone (referred to herein as “ADMP404 microphone”), is amplified by the Analog Devices Model number AD8515 operational amplifier (“referred to herein as “AD8515 amplifier” and corresponding to amplifier 44 of FIG. 2). As active devices, both the ADMP404 microphone and AD8515 amplifier derive their power supply from a bias voltage that is superimposed on the acoustic signal over the single power/signal wire 14B of the shielded line 14. This bias voltage originates as an 8 volt source in series with a 680 ohm resistor R21.

A resistor R8 (680 Ohm) and capacitor C8 (22uF) create a first order low pass filter (fc=1/(2nRC)=10.6 Hz) that substantially reduces acoustic signal interference with the power signal delivered from power supply (i.e., corresponding to the AC filter 50). A zener diode D2 protects the AD8515 amplifier from supply voltages above 5.6 Volt. It should be noted that varying acoustic signal strength should not substantially change the constant supply current (<250uA) of the ADMP404 microphone. Accordingly, this permits a simple series resistor (e.g., resistor R9=14 k) to drop the supply voltage within the limits of the ADMP404 microphone (1.5V to 3.6V). A decoupling capacitor C9 smoothes remaining ripples in the microphone power supply to further improve the signal. 100nF capacitors C7 and C10 complement the larger capacitors by providing power supply decoupling at higher frequencies.

This circuit configures the AD8515 amplifier in a single-supply difference-amplifier configuration, with the microphone power supply providing its bias voltage. The output voltage of the AD8515 amplifier can be calculated to Vout=R5/R1 (V2−V1) with R1=R2 and R5=R9. At a desired microphone sensitivity of 300 mV @ 94 dB SPL, the AD8515 amplifier circuit provides a gain of 18.7 (25.4 dB). Moreover, its output is AC coupled to the shielded line 14 over a 22uF serial capacitor C6.

One challenge with this circuit is the AC load impedance presented to the AD8515 amplifier. It not only drives a >10 Ohm load resistor R20, but faces, in parallel, 680 Ohm resistors R21 and R8. Near the overload point of about 110 dB SPL, the output voltage reaches about 1.5V RMS (4.2V p-p) and the AD8515 amplifier has to drive a current of 4.4mA RMS (1.5V/(R20||R21||R8)=4.4mA). The AD8515 amplifier thus sources this output power (4.4mA×1.5V=6.62 mW) from the 8V power source through the resistors R21 and R8.

At low sound pressure levels, the current consumption of the circuit can be calculated from the 2.4V voltage drop across resistors R21 and R8 (680 Ohm+680 Ohm =1.36 kOhm) between the 8V source and the 5.6V zener diode (2.4V/1.36 kOhm)=1.76mA). Without a zener diode, the quiescent currents of the AD8515 amplifier and ADMP404 microphone (600 uA+250 uA=850 uA max) would set the supply voltage of the AD8515 amplifier to 6.8V (8V-850uA×1.36 kOhm=6.8V), which is above the absolute maximum supply voltage rating.

More current is consumed at high sound pressure levels. The additional supply current required to drive the output increases the current consumption (2.45 mA measured at 110 dB SPL). This in turn reduces the supply voltage of the AD8515 amplifier below the Zener diode voltage (Vsupply=8V-2.45mA×(1.36 kOhm) =4.7V).

Accordingly, in this situation, the output voltage swing of 4.2V p-p is relatively close to the power supply rail of 4.7V. The AD8515 amplifier nevertheless shows excellent rail-to-rail output performance in this situation. Both the ADMP404 microphone and AD8515 amplifier consume only a small amount of quiescent power. The decoupling capacitors store enough energy to reasonably accommodate short sound pressure level peaks above 110 dB. However, it is expected that continuous higher sound pressure levels (up to 120 dB is specified for the ADMP404 microphone) can only be achieved with a phantom power voltage greater than 8V.

The supply voltage of the AD8515 amplifier also impacts its DC bias and the ADMP404 microphone power supply (˜168 uA @2.32V). The circuit thus is dimensioned to provide maximum output signal swing under high sound pressure levels. The DC bias adjusts to half the minimum power supply voltage level of the amplifier (4.7V-(14k×168 uA)=2.35V). The wide supply voltage range and excellent power supply rejection of the ADMP404 microphone compensate for the variation in power supply without performance degradation.

Other components further optimize performance. Specifically, the capacitor C3 separates the microphone DC bias of about 0.8 volts from the amplifier bias (half of its power supply) and AC couples the packaged microphone 21. Capacitor C3 also sets a first order high pass filter with a cut-off frequency of fc=1/(2 pi C3 R1). Furthermore, capacitor C6 performs much of the function of the above noted DC filter 46. Specifically, the capacitor C6 separates the DC bias of the amplifier from the line 14 and AC couples the output of the interface circuit 32 (i.e., the interface circuit power/signal port 38). The value of capacitor C6 determines another high pass filter cutoff frequency (fc=1/(2 pi C6 (R8||R21||R20)=48 Hz).
Moreover, the capacitor C5 may be selected to create a low pass filter (fc=1/(2 pi R5 C5)), while capacitor C3 also adds a low-pass filter pole if a steeper roll-off is desired (fc=1/(2 pi C3 R1)).

The single packaged microphone 21 can be connected either to the positive terminal in non-inverted mode with capacitor C3 being tied to ground, or to the negative terminal for inverted signals with capacitor C4 grounded.

As noted above, this circuit can accommodate other components. For example, this circuit can be used with the Analog Devices packaged microphones having the following model numbers (among other MEMS based packaged microphone):
ADMP401,
ADMP404 and
ADMP405.

Those skilled in the art should note that 1) the ADMP401 has a slightly larger package and therefore has a lower frequency roll-off than the ADMP404 microphone, and 2) the ADMP405 has the highest corner frequency at about 200 Hz and performs better in environments where wind noise is a concern.

For simplicity of explanation, this circuit does not show other components that may further improve performance. For example, the interface circuit 32 may have a small resistor between resistor R9 and the power contact 26 of the ADMP405 microphone. Such a resistor may further fine tune the input power to the ADMP405 microphone. In addition, a transorb diode can be added to increase electrostatic discharge (ESD) robustness, and a series ferrite bead can be added to improve electromagnetic conformance (EMC). For example, the bead should block high frequencies in the tens to hundreds of megahertz range.

FIG. 4 schematically shows a similar circuit to that in FIG. 3, but with an additional ADMP405 microphone. As shown, this circuit is substantially the same as that in FIG. 3, except for an additional ADMP405 microphone and a few changes to the values of some of the components (e.g., resistor R9). Unlike the circuit of FIG. 3, however, the difference in the electrical, analog output signals of the two packaged microphones 21 is amplified by the AD8515 amplifier to create a bidirectional polar pattern. The distance between the packaged microphones 21 also impacts performance.

The components of the interface circuit 32 can be located in any number of locations within the overall system. For example, one skilled in the art can implement the interface circuit 32 as a stand-alone module or card that physically connects between the shielded line 14 and the packaged microphone 21. Alternatively, some or all of it can be integrated into the packaged microphone 21. For instance, all of the components of the interface circuit 32 could be positioned internal to the package protecting the microphone chip 20 and ASIC 22. Accordingly, such a packaged microphone 21 could be configured with two pins/interfaces/pads to more seamlessly connect with the two wires in the line 14.

Accordingly, the interface circuit 32 succeeds in facilitating a connection of the three contacts 26, 28, and 30 of the packaged microphone 21 and a two pronged port of phantom powering schemes. It thus enables packaged (MEMS) microphones 21 to conveniently connect into legacy systems requiring two prongs only.

Although the above discussion discloses various exemplary embodiments of the invention, it should be apparent that those skilled in the art can make various modifications that will achieve some of the advantages of the invention without departing from the true scope of the invention.

What is claimed is:

1. A circuit for electrically connecting a MEMS microphone with a single line transmitting both a DC power signal and an AC information signal, the MEMS microphone having a power interface for receiving the power signal and a separate information interface for delivering the information signal, the circuit comprising:
an information line configured to connect with the information interface of the MEMS microphone, the information line having a DC filter and an information signal output, the DC filter mitigating DC power signals transmitted from the information signal output and toward the information interface of the MEMS microphone;
a power line configured to connect with the power interface of the MEMS microphone, the power line having an AC filter and a power signal input, the AC filter being configured to mitigate information signals directed toward the microphone power interface along the power line from the power signal input; and
an external interface coupled with both the information signal output and the power signal input,
the external interface being a single electrical node that is configured to transmit both a power signal and an information signal.

2. The circuit as defined by claim 1 wherein the power line includes a voltage step down module.

3. The circuit as defined by claim 2 wherein the voltage step down module comprises a diode that sets the maximum voltage on the power line.

4. The circuit as defined by claim 1 further comprising a MEMS microphone with a power interface and an information interface, the power interface coupled with the power line and the information interface coupled with the information line.

5. The circuit as defined by claim 1 wherein the external interface includes a prong or female interface for connecting with a complimentary component terminating a shielded wire.

6. The circuit as defined by claim 1 wherein the single line transmitting both a DC power signal and an AC information signal delivers phantom power.

7. The circuit as defined by claim 1 wherein the signal line comprises an amplifier having an amplifier input for receiving an information signal from the information interface of the MEMS microphone, and an amplifier output for delivering an amplified information signal toward the information signal output.

8. The circuit as defined by claim 7 wherein the amplifier receives power from the power line.

9. The circuit as defined by claim 7 wherein the input comprises a differential input with first and second inputs, the first input being coupled with ground, the second input being coupled with the MEMS microphone.

10. The circuit as defined by claim 7 wherein the input comprises a differential input with first and second inputs, the first input coupled with a first MEMS microphone, the second input coupled with a second MEMS microphone.

11. A circuit for electrically connecting a MEMS microphone with a single line transmitting both a DC power signal and an AC information signal, the MEMS microphone having a power interface for receiving the power signal and an information interface for delivering the information signal, the circuit comprising:
information means for connecting with the information interface of the MEMS microphone, the information means having means for filtering DC signals and an information signal output, the DC filter means mitigating DC power signals transmitted from the information signal output and toward the information interface of the MEMS microphone;
power means for connecting with the power interface of the MEMS microphone, the power means having means for filtering AC signals and a power signal input, the AC filter means being configured to mitigate information signals directed toward the microphone power interface along the power means from the power signal input; and
means for electrically coupling with both the information signal output and the power signal input,
the electrical coupling means being a single electrical node that is configured to transmit both a power signal and an information signal.

12. The circuit as defined by claim 1 wherein the power means includes means for reducing the DC voltage along the power means.

13. The circuit as defined by claim 1 further comprising a MEMS microphone with a power interface and an information interface, the power interface coupled with the power means and the information interface coupled with the information means.

14. The circuit as defined by claim 1 wherein the electrically coupling means includes a connection means for connecting with a complimentary component terminating a shielded wire.

15. The circuit as defined by claim 1 wherein the signal line comprises means for amplifying an information signal from the information interface of the MEMS microphone, the amplifying means including an amplifier means output for delivering an amplified information signal toward the information signal output.

16. The circuit as defined by claim 15 wherein the amplifier receives power from the power means.

17. An apparatus for coupling with a single line transmitting both a DC power signal and an AC information signal, the apparatus comprising:
a MEMS microphone having a power interface for receiving a power signal and an information interface for delivering an information signal;
an information line connected with the information interface of the MEMS microphone, the information line having a DC filter and an information signal output, the DC filter mitigating DC power signals transmitted from the information signal output and toward the information interface of the MEMS microphone;
a power line connected with the power interface of the MEMS microphone, the power line having an AC filter and a power signal input, the AC filter being configured to mitigate information signals directed toward the microphone power interface along the power line from the power signal input; and
an external interface coupled with both the information signal output and the power signal input,
the external interface being a single electrical node that is configured to transmit both a power signal and an information signal.

18. The apparatus as defined by claim 1 wherein the signal line comprises an amplifier having an amplifier input for receiving an information signal from the information interface of the MEMS microphone, and an amplifier output for delivering an amplified information signal toward the information signal output.

19. The apparatus as defined by claim 1 wherein the power line includes a voltage step down module.

20. The apparatus as defined by claim 1 further comprising a housing containing the microphone, power line, information line, DC filter, and AC filter, the apparatus further having a shielded, single line connecting with the external interface, the single line.
